(19) United States
(12) Patent Application Publication
(10) Pub. No.: US 2014/0335471 A1
(43) Pub. Date: Nov. 13, 2014

(54) CAPSULE FOR DENTAL RESTORATIVE MATERIAL

(71) Applicant: Rhondium Holdings Limited, Katikati (NZ)

(72) Inventor: Simon Paul McDonald, Katikati (NZ)

(73) Assignee: RHONDIUM HOLDINGS LIMITED, Katikati (NZ)

(21) Appl. No.: 14/357,688

(22) PCT Filed: Nov. 9, 2012
(86) PCT No.: PCT/US2012/064452

§ 371 Date: May 12, 2014

(30) Foreign Application Priority Data
Nov. 11, 2011 (NZ) 596358
Dec. 9, 2011 (NZ) 596983
Apr. 20, 2012 (NZ) 599503

(51) Int. Cl. A61C 5/06

(52) U.S. Cl. CPC A61C 5/064
USPC 433/90

(57) ABSTRACT

A dental restorative material capsule for mixing and dispensing two flowable materials and dispensing the resulting mixture, comprises a mixing chamber with a removable partition separating the flowable materials prior to use, a plunger for dispensing the contents of the mixing chamber and a dispensing tip for applying the resulting mixture to the desired area.

### FIELD OF THE INVENTION

This invention relates to an improved dental restorative material capsule used to separately hold two restorative materials, and when required for application, allows mixing and delivery of the mixed dental restorative material.

### BACKGROUND OF THE INVENTION

Capsules are used in dentistry for the direct delivery of dental restorative material to the site to be restored. They are usually made up of a main body with compartments for powder and/or liquid material, a stopper to prevent the mixture from leaking out, a plunger to force the materials together, and a nozzle or spout which facilitates the delivery of the mixed dental material.

Conventionally, the two components of the dental restorative material are weighed, mixed on a sheet of paper, and then applied to the restorative site using a spatula or similar equipment. This method is messy and not accurate.

Capsules are single use devices mostly made out of plastic. The components of the capsule are initially stored separately. When the plunger is activated, the components mix. To ensure complete integration of the components, the capsule is placed in a mixer or an amalgamator for a few seconds it is then placed in a dispensing gun and applied to the restoration site.

### SUMMARY OF THE INVENTION

The present invention concerns a disposable, single-use device that holds one or more dental restorative materials in separate chambers until required for use when the barrier preventing communication of the chambers holding the dental restorative materials is removed, the dental restorative materials are mixed together in a mixing chamber and dispensed to the restoration site.

### BRIEF DESCRIPTION OF THE DRAWINGS

FIG. 1 is perspective view of a first embodiment of the present invention;

FIG. 2 is an exploded perspective view of the first embodiment of the present invention;

FIG. 3 is perspective view of the first embodiment of the present invention;

FIG. 4 is a partial cross-sectional view of the first embodiment of the present invention taken along line 4-4 in FIG. 3;

FIG. 5 is perspective view of a second embodiment of the present invention;

FIG. 6 is cross-sectional view of the second embodiment of the present invention;

FIG. 7 is a second cross-sectional view of the second embodiment of the present invention taken along line 7-7 in FIG. 5;

FIG. 8 is a perspective view of a third embodiment of the present invention;

FIG. 9 is a cross-section view of the third embodiment of the present invention taken along line 9-9 in FIG. 8; and

FIG. 10 is a perspective view of a third embodiment of the present invention.

### DETAILED DESCRIPTION OF THE DRAWINGS

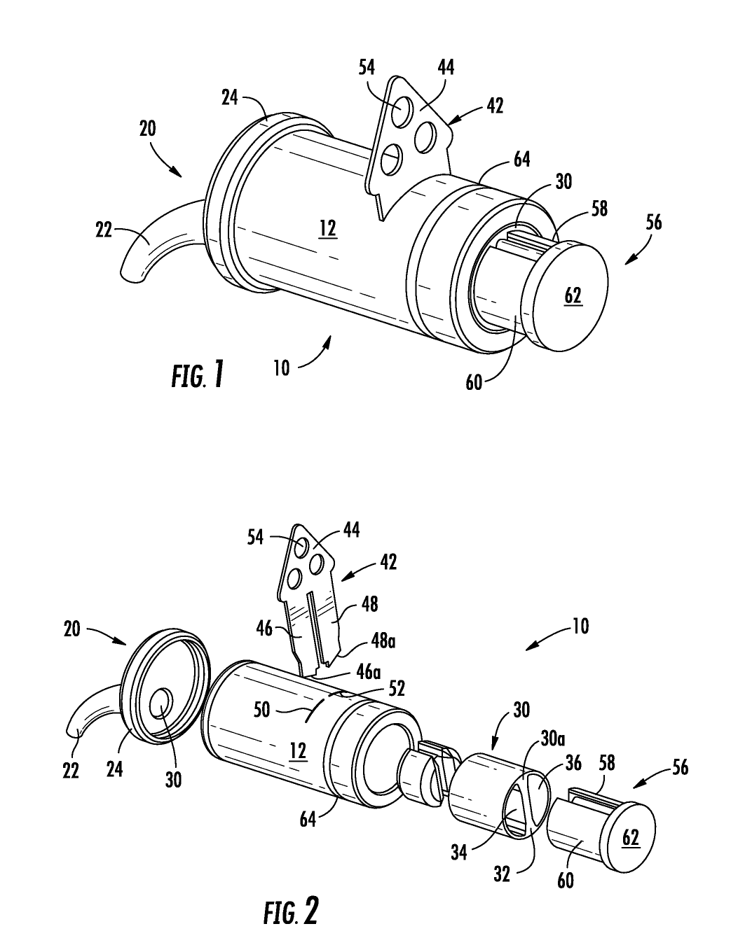

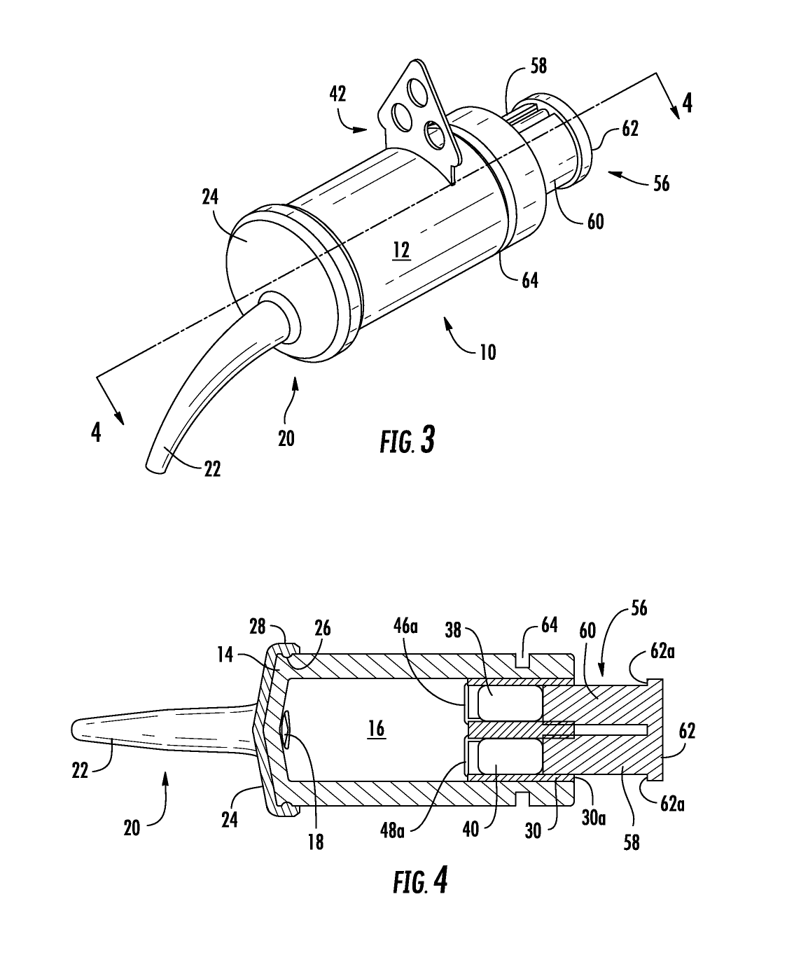

FIGS. 1-4 show a first embodiment of the present invention. The capsule 10 comprises a body member 12. While the body member 12 in this embodiment is shown as a cylinder, alternate shapes may be also be used interchangeably. As shown in the partial cross section view of FIG. 4, the capsule is preferably closed off at the front by front wall 14 and is open-ended at the opposite end. The interior of the body member 12 comprises a mixing chamber 16 and an outlet port 18 on the front wall 14. A dispensing tip 20 consists of a spout 22 and cap 24 that engages the front end of the body member 12. As shown in FIG. 4, the exterior of the body member 12 includes a circumferential groove or channel 26 that corresponds to a ridge 28 on the interior of the cap 24 to enable the dispensing tip 20 to snap-fit into place with the body member 12. This means for attaching the dispensing tip 20 to the body member is intended to be exemplary in nature and can substituted for other suitable means of attaching members. The cap 24 further comprises a bore 30 that aligns with the outlet port 18 in the body member 12 and creates a passageway for material to be dispensed from the mixing chamber 16, through the outlet port 18, through the bore 30 and exit the capsule 10 through the spout 22. The spout 22 is located towards the outer edge of the cap 24 to enable the contents of the mixing chamber 16 to be easily dispensed when the capsule 10 is horizontal or tipped slightly above horizontal. A sealing member, such as plug (not shown), caps the end of the spout 22 and prevents leakage from the mixing chamber 16. Alternatively, a punctureable seal over the bore 30 can, independently or in connection with the cap, prevent leakage through the spout 22.

The open end of the body member 12 is configured to receive a materials cartridge 30. The cartridge 30 comprises a hollow interior with a central divider 32 creating a first and second internal chamber 34, 36 for receiving a first and second amount of dental restorative materials 38, 40. As shown in FIG. 2, when the cartridge is cylindrical, first and second internal chambers 34, 36 will be semi-circular in configuration and. In the embodiment of the invention shown in FIG. 2, the central divider 32 divides the interior of the cartridge 30 into equal chambers that run the length of the cartridge 30. In other embodiments it is contemplated that the central divider 32 may be offset from the center of the cartridge 30, creating in chambers 34, 36 that are of different volume.

A removable separating shim 42 is received by the body member 12 and extends through the mixing chamber 16. As seen in FIG. 2, the separating shim comprises a tab 44 and first and second legs 46, 48 that are received by slots 50, 52 on the body member 12. The slots 50, 52 are positioned on the body member 12 to enable the legs 46, 48 to act as a stop for insertion of the cartridge 30 into the mixing chamber and also function as a barrier or gate controlling access to the front end of the cartridge 30 and preventing material 38, 40 from prematurely leaking or seeping from the chambers 34, 36 into the mixing chamber 16. As the legs 46, 48 extend entirely through the mixing chamber 16, the ends of the legs 46a, 48a are contoured to the shape of the mixing chamber 16. The tab 44 may include a roughened surface or at least a first bore 54 to ease in grabbing and manipulating the separating shim 42.

A dual-barrel plunger 56 comprises a first and second ram 58, 60 and a pad 62. Each ram 58, 60 is configured to be received by a chamber 34, 36 in the cartridge 30, such that advancing the plunger 56 results in the rams 58, 60 pushing the resin material 38, 40 from the chambers 34, 36 and into the mixing chamber 16. To prevent leakage out of the back of the cartridge 30, the rams 58, 60 are sized to fit snuggly into the chamber 34, 36. The rams 58, 60 in this embodiment are connected by the way of the pad 62 and will move in unison. In other embodiments, the rams 58, 60 may also be separate and able to move independently of one another.

The rams 58, 60 extend from the pad 62 offset from the outer edge of the pad 62 forming a lip 62a and, preferably, the length of the rams 58, 60 corresponds to the length of the chambers 34, 36. When the plunger 56 is depressed such that the rams 58, 60 are fully inserted into the chamber 34, 36, the lip 62a comes into contact with the back edge 30a of the cartridge 30 and the front, pushing surfaces of the rams 58, 60 and the front surface of the cartridge 30 will form a substantially uniform, unitary pushing surface. Continued depression of the plunger 56 results in the unitary pushing surface urging the material from the mixing chamber 16 into the dispensing tip 20.

A second circumferential groove or channel 64 on the exterior of the body member provides a point of attachment for a mixer or amalgamator, dispensing gun (not shown).

In operation, the capsule 10 shown in FIGS. 1-4 is prepackaged with composite resin 38, 40 in the cartridge 30 during manufacture and assembly of the capsule 10. Immediately prior to use of the capsule 10, the separating shim 44 is removed and the plunger 56 depressed pushing the composite resin 38, 40 from the chambers 34, 36 into the mixing chamber 16. The capsule 10 is placed into a mixer or amalgamator to allow the composite resins 38, 40 to combine. The circumferential channel or grove 64 on the body 12 provides a point of secure attachment to the mixer or amalgamator and provides secure point of attachment of the capsule 10 to a dispensing gun. Once the capsule 10 is secured in the dispensing gun the sealing member in the spout 22 is removed and the composite resin is dispensed directly onto the restoration site.

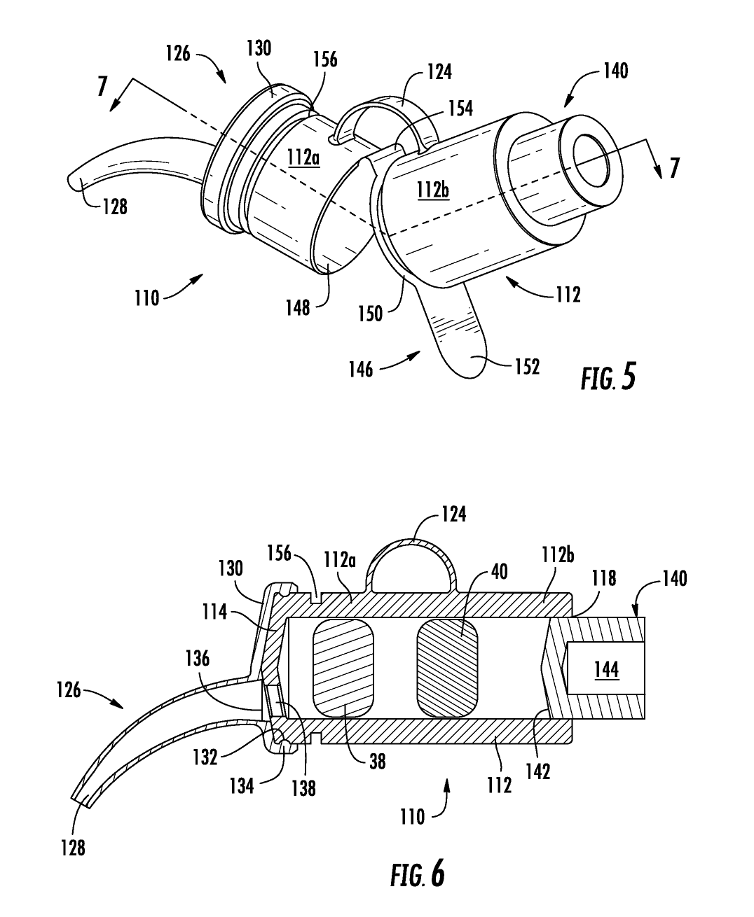

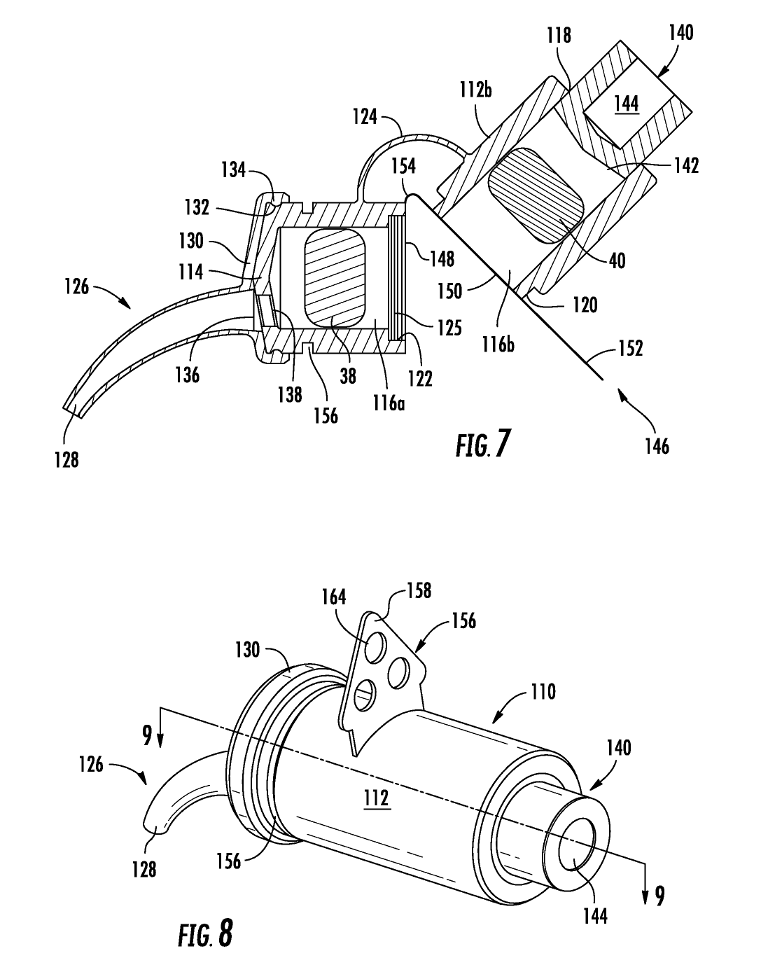

FIGS. 5-7 show a second embodiment of the inventive dental restorative material capsule. Capsule 110 includes a cylindrical body member 112 separated into a forward section 112a and rear section 112b. The front of the forward section 112a is closed off by front wall 114 and open at the oppose end 116a. The rear section 112b is open at both ends 116b, 118. Open ends 116a, 116b are configured to mate together to form a continuous mixing chamber 116. As shown best in FIG. 7, the open end 116b of the rear section 112b terminates in an annular ring or ridge 120 and the open end 116a of the forward section 112a includes a circumferential notch or channel 122 configured to receive the ridge 20. The forward and rear sections 112a, 112b are connected by a live hinge 124 that biases the sections together to seal the mixing chamber 116,

The circumferential notch or channel 122 may also be fitted with a sealing member 125 to further seal the mixing chamber 116. The sealing member 125 may consist of an O-Ring or an annular ring with at least a first ridge or at least a first fin to provide a seal between the forward section 112a and rear section 112b by press-fit engagement. While the sealing member 125 is shown to be placed at the end 116a of the forward section 112a, the sealing member may also be placed at the end 116b of the rear section 112b or each section 112a, 112b may consist of a sealing member working in conjunction with each other.

A dispensing tip 126 consists of a spout 128 and cap 130 that engages the front end of the body member 112. As seen best in FIGS. 6 and 7, the exterior of the body member 112 includes a circumferential groove or channel 132 that corresponds to a ridge 134 on the interior of the cap 130 to enable the dispensing tip 126 to snap-fit into place with the body member 112. This means for attaching the dispensing tip 126 to the body member is intended to be exemplary in nature and can be substituted for other suitable means of attaching members. The cap 130 further comprises a bore 136 that aligns with the outlet port 138 in the body member 112 and creates a passageway for material to be dispensed from the mixing chamber 116, through the outlet port 138, through the bore 136 and exit the capsule 110 through the spout 128. A sealing member, such as plug (not shown), caps the end of the spout 128 and prevents leakage from the mixing chamber. Alternatively, a punctureable seal over the bore 136 can, independently or in connection with the cap, prevent leakage through the spout 128. The spout 128 is located towards the edge of the cap 130 to enable the contents of the mixing chamber 116 to be easily dispensed when the capsule 110 is horizontal or tipped slightly above horizontal.

A plunger 140 is configured to insert within the open end 118 of the rear section 112b. The plunger 140 fits snuggly into the rear section 112b to prevent material from the mixing chamber 116 from leaking or seeping out of the capsule 110 at this interface. As seen in FIGS. 6 and 7, the plunger 140 includes a front pushing surface 142 that will contact and “push” the material in the mixing chamber 116. The front pushing surface 142 is shown to taper to a tip. This contour corresponds to the contour of the front wall 114 to enable the plunger 140 and front pushing surface to travel the maximum length of the mixing chamber 116 and urge the maximum amount of material from the mixing chamber 116 and out the spout 128. The plunger 140 may also be hollowed out to form a cavity 144 for receiving a ram (not shown) in a dispensing gun or to save on the amount of material used to form the plunger.

Referring to FIG. 7, the forward and rear sections 112a, 112b of the body member 112 are sealed by sealing member 146 before the capsule is put into use. The sealing member 144 is preferably made of a removable foil material that will prevent the premature release and mixing of the contents of the forward and rear sections 112a, 112b, In FIG. 7, the sealing member consists of a first portion 148 covering the open end 116a of the forward section 112a, a second section 150 covering the open end 116b of the rear section 112b and a tab 152 extending from the second section 150. In the embodiment shown in FIG. 7, the sealing member is a single, continuous piece of foil with a fold-over or web portion 154 extending between the first and second sections 148, 150. It is contemplated in other embodiments of the invention that each open end 116a, 116b will be covered by a separate sealing member, each having a tab to assist in removing the sealing member when the capsule 110 is in use.

A second circumferential groove or channel 156 on the exterior of the body member provides a secure point of attachment for a mixer or amalgamator, dispensing gun (not shown).

FIGS. 8-10 show a third embodiment of the inventive dental restorative material capsule, Whenever possible like reference numbers used to described FIGS. 5-7 will be used in the description of these figures. The capsule 110 includes a cylindrical body member 112, closed off by a front wall 114 at one end and open at the opposite end 118. The interior of the body member 112 defines a mixing chamber 116. An outlet port 138 is positioned on the front wall 114.

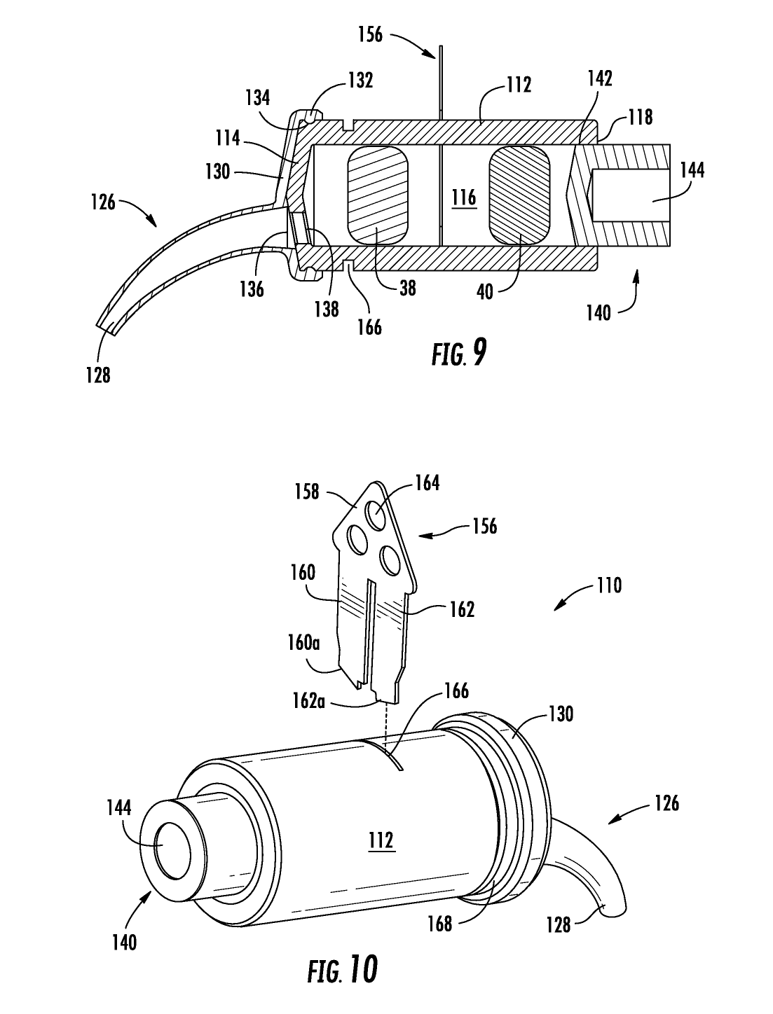

A dispensing tip 126 consists of a spout 128 and cap 130 that engages the front end of the body member 112. As seen best in FIG. 9, the exterior of the body member 112 includes a circumferential groove or channel 132 that corresponds to a ridge 134 on the interior of the cap 130 to enable the dispensing tip 126 to snap-fit into place with the body member 112. This means for attaching the dispensing tip 126 to the body member is intended to be exemplary in nature and can substituted for other suitable means of attaching members. The cap 130 further comprises a bore 136 that aligns with the outlet port 138 in the body member 112 and creates a passageway for material to be dispensed from the mixing chamber 116, through the outlet port 138, through the bore 136 and exit the capsule 110 through the spout 128. A sealing member, such as plug (not shown), caps the end of the spout 128 and prevents leakage from the mixing chamber. Alternatively, a punctureable seal over the bore 136 can, independently or in connection with the cap, prevent leakage through the spout 128. The spout 128 is located towards the edge of the cap 130 to enable the contents of the mixing chamber 116 to be easily dispensed when the capsule 110 is horizontal or tipped slightly above horizontal.

A plunger 140 is configured to insert within the open end 118 of the body member 112. The plunger 140 fits snuggly into the open end 118 to prevent material from the mixing chamber 116 from leaking or seeping out of the capsule 110 at this interface. As seen in FIG. 9, the plunger 140 includes a front pushing surface 142 that will contact and “push” the material in the mixing chamber 116. The front pushing surface 142 is shown to taper to a tip. This contour corresponds to the contour of the front wall 114 to enable the plunger 140 and front pushing surface to travel the maximum length of the mixing chamber 116 and urge the maximum amount of material from the mixing chamber 116 and out the spout 128. The plunger 140 may also be hollowed out to form a cavity 144 for receiving a ram (not shown) in a dispensing gun or to save on the amount of material used to form the plunger.

A removable separating shim 156 is received by the body member 112 and extends through the mixing chamber 116. As seen in FIGS. 9 and 10, the separating shim 156 comprises a tab 158 and first and second legs 160, 162 that are received by slots 166 on the body member 112. When the separating shim 156 is inserted into the body member 112, the legs 160, 162 divide the mixing chamber 116 into a forward section 116a and rear section 116b and prevents materials from each section from communicating and mixing with each other. As the legs 160, 162 extend entirely through the mixing chamber 116, the ends of the legs 160a, 162a are contoured to the shape of the mixing chamber 116. The tab 158 may include a roughened surface or at least a first bore 164 to ease in grabbing and manipulating the separating shim 156.

A second circumferential groove or channel 168 on the exterior of the body member provides a secure point of attachment for a mixer or amalgamator, dispensing gun (not shown).

In operation, the capsule 110 shown in FIGS. 5-10 is prepackaged with composite resin 38, 40 during manufacture and assembly of the capsule 110. Immediately prior to use of the capsule 110, the separating means (the sealing member 146 or separating shim 156) is removed. In the embodiment shown in FIG. 5-7, the forward section 112a and rear section 112b are joined together to close the mixing chamber 116. The capsule 110 is placed into a mixer or amalgamator to allow through mixing of the restorative materials 38, 40 and the capsule is placed into a dispensing gun. As the plunger 140 is depressed, the resin mixture is extruded through the dispensing tip 126 and delivered to the site of the restoration.

While the present invention has been described in connection with a specific application, this application is exemplary in nature and is not intended to be limiting on the possible applications of this invention. It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

I claim:

1. A dental restorative material capsule comprising:
a body member having a closed front wall and an open end opposite the front wall,
a mixing chamber in the interior of the body member;
a dispensing tip in fluid communication with the mixing chamber;
a cartridge configured to be received in the mixing chamber through the open end of the body member, the cartridge comprising a central divider defining a first and second cartridge chamber, each cartridge chamber including an open-ended front and back section;
a removable shim configured to be received by the body member and extend through the mixing chamber, the removable shim positioned in the mixing chamber to provide a seal on the open ends of the front section of the first and second cartridge chambers and provide a boundary on insertion of the cartridge into the mixing chamber; and
a plunger comprising a first and second ram, the first ram configured to engage and be received by the first cartridge chamber at the open-ended back section and the second ram configured to engage and be received by the second cartridge chamber at the open-ended back section,
wherein removal of the shim and depressing the plunger causes a first amount of material in the first cartridge chamber and a first amount of material in the second cartridge chamber to be urged into the mixing chamber.

2. The dental restorative material capsule of claim 1 wherein the body member is a cylinder.

3. The dental restorative material capsule of claim 1 wherein the first and second materials comprise a first and second dental restorative material.

4. The dental restorative material capsule of claim 1 wherein the cartridge is cylindrical and the first and second material chambers have a semi-circular cross section.

5. The dental restorative material capsule of claim 1 wherein the central divider in the cartridge is positioned wherein the first and second cartridge chambers are of equal cross sectional area.

6. The dental restorative material capsule of claim 1 wherein the removable shim consists of a tab portion and a first and second leg extending from the tab.

7. The dental restorative material capsule of claim 6 wherein the body member consists of a first slot configured to receive the first leg of the shim and a second slot configured to receive the second leg of the shim.

8. The dental restorative material capsule of claim 1 wherein the dispensing tip consists of: a spout, a cap, the cap configured to releasable engage the cylindrical body member, and a bore in the cap and positioned to align with the front wall outlet port when the dispensing tip attaches to the body member.

9. The dental restorative material capsule of claim 8 wherein the cap consists of ridge and the body member consists of a circumferential channel on its outside surface and configured to receive the ridge to enable snap-fit engagement between the dispensing tip and body member.

10. The dental restorative material capsule of claim 1 wherein the body member further consists of a dispensing gun receiving circumferential channel on the outside surface of the body member.

11. The dental restorative material capsule of claim 1 wherein the plunger further consists of a pad the first and second rams each extend from the end surface.

12. The dental restorative material capsule of claim 11 wherein the pad further consists of a lip, the lip coming into contact with a back edge of the cartridge when the first and second rams are fully inserted into the first and second cartridge chambers, and a front edge of the cartridge and a front pushing surface on each of the first and second rams forms a unitary pushing surface

13. The dental restorative material capsule of claim 1 further consisting of a plug configured closing the spout.

14. The dental restorative material capsule of claim 1 further consisting of a rupturable seal closing the spout.

15. The dental restorative material capsule of claim 1 further consisting of an outlet port on the front wall enabling fluid communication between the mixing chamber and the dispensing tip.

16. A dental restorative material capsule comprising:
a body member consisting of a forward section and a rear section, the forward and rear sections operatively connected by a hinge biased to engage the forward and rear sections together;
a dispensing tip in fluid communication with the forward section;
a plunger operatively associated with the rearward section;
a removable sealing member sealing an open end of the forward section and a removable sealing member sealing an open end of the rear section;
a mixing chamber formed by the removal of the sealing members and biasing of the forward and rear sections into engagement by the hinge.

17. The dental restorative material capsule of claim 16 wherein the body member is a cylinder.

18. The dental restorative material capsule of claim 16 wherein the dispensing tip consists of: a spout, a cap, the cap configured to releasable engage the cylindrical body member, and a bore in the cap and positioned to align with the front wall outlet port when the dispensing tip attaches to the body member.

19. The dental restorative material capsule of claim 18 wherein the cap consists of ridge and the body member consists of a circumferential channel on its outside surface and configured to receive the ridge to enable snap-fit engagement between the dispensing tip and body member.

20. The dental restorative material capsule of claim 16 wherein the body member further consists of a dispensing gun receiving circumferential channel on the outside surface of the body member.

21. The dental restorative material capsule of claim 16 further consisting of a plug configured to close the spout.

22. The dental restorative material capsule of claim 16 further consisting of a ruptureable seal to close the spout.

23. The dental restorative material capsule of claim 16 wherein the sealing members on the forward and rear sections consists of a unitary member having a first section, a second section, the first and second sections connect by fold-over portion, and a tab extending from the second section.

24. The dental restorative material capsule of claim 16 wherein the plunger has a front pushing surface, the front pushing surface having a contour that is complimentary to a contour of a front wall closing a forward end of the body member.

25. The dental restorative material capsule of claim 16 further consisting of a sealing member disposed between the forward and rear sections and sealing the mixing chamber when the forward and rear sections are biased into engagement by the hinge.

26. The dental restorative material capsule of claim 25 wherein the sealing member consists of an O-ring.

27. The dental restorative material capsule of claim 25 wherein the sealing member consists of an annular ring having at least a first fin on an inner surface of the ring.

28. The dental restorative material capsule of claim 25 wherein the sealing member is positioned in a circumferential channel in the forward section.

29. A dental restorative material capsule comprising:
a body member having a closed front wall and an open end opposite the front wall, and an internal mixing chamber;
a dispensing tip in fluid communication with the mixing chamber;
a removable shim configured to be received in the body member and extend through the mixing chamber, the removable shim positioned in the mixing chamber to divide the mixing chamber into a forward and a rear section; and
a plunger operatively mated to the open end of the body member.

30. The dental restorative material capsule of claim 29 wherein the body member is a cylinder.

31. The dental restorative material capsule of claim 29 wherein the dispensing tip consists of: a spout, a cap, the cap configured to releasable engage the cylindrical body member, and a bore in the cap and positioned to align with an outlet port in the front wall when the dispensing tip attaches to the body member.

32. The dental restorative material capsule of claim 31 wherein the cap consists of ridge and the body member consists of a circumferential channel on its outside surface and configured to receive the ridge to enable snap-fit engagement between the dispensing tip and body member.

33. The dental restorative material capsule of claim 29 wherein the body member further consists of a dispensing gun receiving circumferential channel on the outside surface of the body member.

34. The dental restorative material capsule of claim 29 wherein the removable shim consists of a tab portion and a first and second leg extending from the tab.

35. The dental restorative material capsule of claim 34 wherein the body member consists of a first and second slot configured to receive the first and second legs of the shim.

36. The dental restorative material capsule of claim 29 wherein the plunger has a front pushing surface, the front pushing surface having a contour that is complimentary to a contour of a front wall closing a forward end of the body member.
